(19) United States
(12) Patent Application Publication
(10) Pub. No.: US 2007/0160123 A1
(43) Pub. Date: Jul. 12, 2007

(54) SYSTEM FOR ISOLATING AN OBJECT IN A BROADCAST SIGNAL

(76) Inventor: Richard P. Gillespie, Madison, CT (US)

Correspondence Address: LAW OFFICE OF MARC D. MACHTINGER, LTD., 750 W. LAKE COOK ROAD, SUITE 350, BUFFALO GROVE, IL, 60089, US

(21) Appl. No.: 11/306,786

(22) Filed: Jan. 11, 2006

(51) Int. Cl. H04L 5/16; H04L 27/00; G06K 9/00

(52) U.S. Cl. 375/222; 375/316; 382/181

(57) ABSTRACT

A system for isolating an object in a broadcast signal is disclosed. The system scans the broadcast signal for at least one identifiable object and selectively filters the broadcast signal. In selectively filtering the broadcast signal, the identifiable object is selectively passed or removed from the broadcast signal. The identifiable object can include, but is not limited to, an image or a logo (such as a company or brand image, which may or may not be a trademarked image). The identifiable object can also include, but it not limited to an audio clip, such a word, phrase, or name. In various preferred embodiments, each frame of the broadcast signal is scanned and analyzed for the identifiable object.

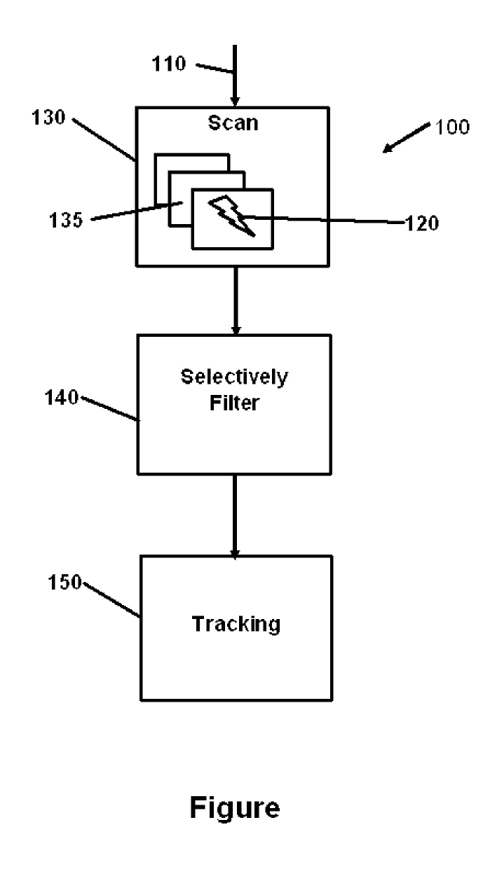

### FIELD OF THE INVENTION

The present invention relates to television broadcast signals. More specifically, the present invention relates to systems and methods for isolating an object in a broadcast signal.

### DESCRIPTION OF THE RELATED ART

Television broadcasters are increasingly looking for new forms of revenue to supplement the traditional advertising revenue generated by airing commercials during a broadcast. The advent of video cassette recorders and more recently the advent of digital video recorders allows the viewer to fast forward or skip over commercials. In addition, the habit of channel surfing, that is the changing of channels while one channel is airing a commercial, is becoming more commonplace. Thus broadcasters, and their sources of revenue, the program sponsors, are looking for new ways of getting their products before the viewing public.

One way of getting products before the public is to pay to have a product used in a particular television program. For example, a carmaker may pay to have the actors of a program use their vehicles in a television program or movie. While these product placements may be effective in prerecorded or prefilmed programming, they are not conducive to live broadcasts.

To get products before the public in live broadcasts there are generally two forms of advertising employed. The first form is for the advertiser to buy space at the venue of the broadcast. For example, the sponsor buys/rents a sign at a ball park in the hopes that the sign will be seen by the television cameras, and ultimately the viewers. To the broadcaster this first form of advertising is not appealing because the broadcaster does not receive the revenue, the venue receives the revenue.

Another form is for the advertiser to sponsor a portion of the broadcast or a specific event in the broadcast. For example, an announcer may say, “This inning is brought to you by XYZ Corp., the maker of Widgets;” or announce the ABC Co. player of the game. Another example may include the insertion of a company logo or name as part of the broadcast, such as the XYZ Corp. logo as part of a game clock shown as part of the broadcast.

While this second form is more appealing to broadcaster, there exists a great possibility of the viewer receiving mixed messages because other objects on the screen or in the audio stream. For example, if a broadcast is being sponsored by XYZ Corp. and someone wearing an ABC Co. t-shirt is in the front row, every time the camera pans past the person, ABC Co. effectively gets free advertising while XYZ Corp. is paying to sponsor the broadcast. The problem becomes particularly acute when ABC and XYZ are competitors.

Advancements in computer enhanced graphics and video object tracking may lead to a solution to this problem. U.S. Pat. No. 6,870,945, issued to Schoepflin et al., discloses ways of video object tracking by estimating and subtracting background. According to Schoepflin, an object is tracked among a plurality of image frames. An operator selects the object in an initial frame and the object is distinguished from the remaining background portions of the image to yield a background and a foreground. Models of the background and foreground are used and updated in subsequent frames. Pixels in subsequent frames are classified as belonging to the background or the foreground.

U.S. Pat. No. 5,892,1999, issued to DiCicco et al., discloses a system and method for inserting static and dynamic images into a live video broadcast. According to DiCicco, the live video insertion system efficiently places static or dynamic images into a live broadcast. The system initially identifies natural landmarks within the video scene that can be automatically identified and tracked as the field of view of the camera pans and zooms across the scene. The locations of the landmarks are mathematically modeled and stored as a constellation of locations on a mathematical grid. An arbitrary reference point, preferably no necessarily coincident with a selected natural landmark, is located within or without of the grid and used as an origin for the purpose of inserting the static or dynamic image within the field of view of the camera.

U.S. Pat. No. 5,917,553, issued to Honey et al., discloses a method and apparatus for enhancing the broadcast of a live event. According to Honey '553, pan, tilt, and zoom sensors are coupled to a broadcast camera in order to determine the field of view of the broadcast camera and to make a rough estimate of a target's location in the broadcast camera's field of view. Pattern recognition techniques can be used to determine the exact location of the target in the broadcast camera's field of view. If a preselected target is at least partially within the field of view of the broadcast camera, all or part of target's image is enhanced. The enhancements include replacing the target image with a second image, overlaying the target image or highlighting the target image. Examples of a target include a billboard, a portion of a playing field or another location at a live event.

Furthermore, U.S. Pat. No. 6,466,275, issued to Honey et al., discloses a system to enhance a video of an event at a remote location using data acquired at the event. According to Honey '275, sensors are used at the event to acquire information. The sensors can include pan, tilt, and zoom sensors used to acquire camera view information. At the studio, the sensor information is used to enhance the video for broadcast. The enhancements can include the drawing of lines or other shapes in the video, adding advertisements to the video, or adding graphics to the video.

While each of these patents may be useful in the broadcast industry, they do not address isolating an object in a broadcast signal, particularly without the use of complex sensors and models of the camera field of view and the venue. Accordingly, there remains a need for system of isolating an object in a broadcast signal. Thus it would be advantageous to provide a system for isolating an object in a broadcast signal.

### SUMMARY

In view of the deficiencies described above, it is an object of the present invention to provide a system for isolating an object in a broadcast signal. It is a further object of the present invention to provide a method of isolating an object in a broadcast signal.

The present invention is a system for isolating an object in a broadcast signal. The system scans the broadcast signal for at least one identifiable object and selectively filters the broadcast signal. In selectively filtering the broadcast signal, the identifiable object is selectively passed or removed from the broadcast signal. The identifiable object can include, but is not limited to, an image or a logo (such as a company or brand image, which may or may not be a trademarked image). The identifiable object can also include, but it not limited to an audio clip, such a word, phrase, or name. In various preferred embodiments, each frame of the broadcast signal is scanned and analyzed for the identifiable object.

When the system finds the identifiable object, the identifiable object is either removed from the broadcast signal or allowed to pass. Removing the identifiable object can include, but is not limited to, fading the identifiable object, obscuring the identifiable object, or replacing the identifiable object with another image or logo. Removing the identifiable object can also include, but is not limited to, muting an audio clip, or replacing an audio clip with another audio clip.

The system can also include a tracking function, which tracks the number of time an identifiable object is selectively passed or removed from the broadcast signal.

The present invention also includes a method of isolating an object in a broadcast signal. The method includes the steps of scanning a broadcast signal for at least one identifiable object, and selectively filtering said broadcast signal, wherein said identifiable object is selectively passed or removed from said broadcast signal. Scanning the broadcast signal can include scanning each frame of the broadcast signal, and analyzing each frames for the identifiable object. Analyzing each frame for the identifiable object can include processing each frame through one or more neural networks trained to recognize the identifiable object. The method can also include tracking the number of times the identifiable object is selectively passed or removed from said broadcast signal.

Other features and advantages of the invention will be apparent from the following detailed description taken in conjunction with the following figures, wherein like reference numerals represent like features.

### BRIEF DESCRIPTION OF THE FIGURE

The FIGURE shows a system of isolating an object in a broadcast signal according to the present invention in block diagram form.

### DETAILED DESCRIPTION OF THE INVENTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspect of the invention to the embodiments illustrated.

The present invention is a system for isolating an object in a broadcast signal. The FIGURE shows a system of isolating an object in a broadcast signal according to the present invention in block diagram form. The system 100 scans 130 the broadcast signal 110 for at least one identifiable object 120 and selectively filters 140 the broadcast signal 110. In selectively filtering the broadcast signal 110, the identifiable object 120 is selectively passed or removed from the broadcast signal 110. The identifiable object 120 can include, but is not limited to, an image or a logo (such as a company or brand image, which may or may not be a trademarked image). The identifiable object 120 can also include, but it not limited to an audio clip, such a word, phrase, or name.

In various preferred embodiments, each frame 135 of the broadcast signal 110 is scanned and analyzed for the identifiable object 120. This can be accomplished by capturing the broadcast signal 110 and breaking it down into frames 135. The frames 135 can be queued into a database. The frames 135 can be processed by one or more neural networks train to recognize the identifiable object 120.

In various preferred embodiments, these processes are carried out on one or more computers. These computers can be configured to operate in one or more virtual operating systems within one or more blade-type servers contained within a blade-type server center. For example, each neural network can be maintained and run its own virtual operating system. In other various embodiments, the processes are carried out on multiple physical servers and multiple operating systems, with multiple processes running within each operating system.

When the system 100 finds the identifiable object 120, the identifiable object is either removed from the broadcast signal 110 or allowed to pass. Removing the identifiable object 120 can include, but is not limited to, fading the identifiable object 120, obscuring the identifiable object 120 or replacing the identifiable object 120 with another image or logo. Removing the identifiable object 120 can also include, but is not limited to, muting an audio clip or replacing an audio clip with another audio clip.

The system 100 can also include a tracking function 150, which tracks the number of time an identifiable object 120 is selectively passed or removed from the broadcast signal 110. This function allows the broadcaster or operator of the system 100 to operate as a pay per use type of operation.

The present invention also includes a method of isolating an object in a broadcast signal. The method includes the steps of scanning a broadcast signal for at least one identifiable object, and selectively filtering said broadcast signal, wherein said identifiable object is selectively passed or removed from said broadcast signal. Scanning the broadcast signal can include scanning each frame of the broadcast signal, and analyzing each frames for the identifiable object. Analyzing each frame for the identifiable object can include processing each frame through one or more neural networks trained to recognize the identifiable object. The method can also include tracking the number of times the identifiable object is selectively passed or removed from said broadcast signal.

While specific embodiments have been illustrated and described, numerous modifications come to mind without significantly departing from the spirit of the invention and the scope of protection is limited by the scope of the accompanying claims.

What is claimed is:

1. A system for isolating an object in a broadcast signal, comprising:
computer implemented means for scanning said broadcast signal for at least one identifiable object, and
computer implemented means for selectively filtering said broadcast signal, wherein said identifiable object is selectively passed or removed from said broadcast signal.

2. The system for isolating an object in a broadcast signal according to claim 1, wherein said computer implemented means for scanning said broadcast signal for at least one identifiable object comprises:
computer implemented means for scanning each frame of said broadcast signal, and computer implemented means for analyzing each of said frames for said at least one identifiable object.

3. The system for isolating an object in a broadcast signal according to claim 2, wherein said computer implemented means for analyzing each of said frames for said at least one identifiable object comprises computer implemented means for processing each frame through at least one neural network, wherein said at least one neural network has computer implemented means for recognizing said at least one identifiable object.

4. The system for isolating an object in a broadcast signal according to claim 1, wherein said system further comprises computer implemented means for tracking the number of times said at least one identifiable object is selectively passed or removed from said broadcast signal.

5. The system for isolating an object in a broadcast signal according to claim 1, wherein said at least one identifiable object comprises an image.

6. The system for isolating an object in a broadcast signal according to claim 5, wherein said image comprises a logo.

7. The system for isolating an object in a broadcast signal according to claim 1, wherein said at least one identifiable object comprises an audio clip.

8. The system for isolating an object in a broadcast signal according to claim 7, wherein said audio clip comprises a name.

9. The system for isolating an object in a broadcast signal according to claim 7, wherein said audio clip comprises a phrase.

10. The system for isolating an object in a broadcast signal according to claim 7, wherein said audio clip comprises a word.

11. The system for isolating an object in a broadcast signal according to claim 5, wherein said identifiable object is removed from said broadcast signal comprises fading said image.

12. The system for isolating an object in a broadcast signal according to claim 5, wherein said identifiable object is removed from said broadcast signal comprises obscuring said image.

13. The system for isolating an object in a broadcast signal according to claim 5, wherein said identifiable object is removed from said broadcast signal comprises replacing said image with another image.

14. The system for isolating an object in a broadcast signal according to claim 7, wherein said identifiable object is removed from said broadcast signal comprises muting said audio clip.

15. The system for isolating an object in a broadcast signal according to claim 5, wherein said identifiable object is removed from said broadcast signal comprises replacing said audio clip with another audio clip.

16. A method of isolating an object in a broadcast signal comprising the steps of:
scanning said broadcast signal for at least one identifiable object, and
selectively filtering said broadcast signal, wherein said identifiable object is selectively passed or removed from said broadcast signal.

17. The method of isolating an object in a broadcast signal according to claim 16, scanning said broadcast signal for at least one identifiable object comprises:
scanning each frame of said broadcast signal, and
analyzing each of said frames for said at least one identifiable object.

18. The method of isolating an object in a broadcast signal according to claim 17, wherein analyzing each of said frames for said at least one identifiable object comprises processing each frame through at least one neural network, wherein said at least one neural network has computer implemented means for recognizing said at least one identifiable object.

19. The method of isolating an object in a broadcast signal according to claim 16, wherein said method further comprises the step of tracking the number of times said at least one identifiable object is selectively passed or removed from said broadcast signal.
